(19) United States
(12) Patent Application Publication
(10) Pub. No.: US 2017/0324518 A1
(43) Pub. Date: Nov. 9, 2017

(54) AN ADAPTIVE BLOCK ACK MECHANISM FOR A-MDPU

(71) Applicant: INTEL CORPORATION, Santa Clara, CA (US)

(72) Inventors: Peng MENG, Shanghai (CN); Rongzhen YANG, Shanghai (CN); Qinghua LI, San Ramon, CA (US)

(21) Appl. No.: 15/522,922

(22) PCT Filed: Dec. 12, 2014
(86) PCT No.: PCT/CN2014/093712

§ 371 Date: Apr. 28, 2017

(51) Int. Cl. H04L 1/08; H04L 1/16; H04L 12/26

(52) U.S. Cl. CPC H04L 1/08; H04L 43/0829; H04L 1/1621; H04L 1/1685

(57) ABSTRACT

Techniques for presenting communication between two or more stations in a WLAN environment are provided. Specifically, methods are presented, that when taken alone or together, provide a device or group of devices with an efficient way of selecting the appropriate BA size based on changes in the environment. The present disclosure includes a method that provides a wireless device with the option to use various packets per bit in a block acknowledgment mechanism based on a window duration and packet error rate.

### TECHNICAL FIELD

An exemplary embodiment pertains to wireless networks. Some embodiments relate to wireless networks that operate in accordance with one of the Institute of Electrical and Electronics Engineers (IEEE) 802.11 standards including the IEEE 802.11-2012 standards. Some embodiments relate to a wireless network communicating using aggregate data frames. Exemplary embodiments also relate to the communication between two or more stations using an adaptive block acknowledgement mechanism.

### BACKGROUND

Technological develops such as OFDM and MIMO are being implemented at the physical layer by WLAN standards such as 802.11 in an effort to increase capacity. However, such capacity growth is stunted by the Media Access Control (MAC) layer and its large overhead. Therefore, recent developments in the 802.11 standard have be added to overcome such shortcomings. For example, in IEEE 802.11n, the concept of frame aggregation was introduced at the MAC level. In frame aggregation, multiple frames are aggregated into a single large frame with a common MAC header in an effort to decrease overhead. One such aggregate scheme is the Aggregate Media Access Control Protocol Data Unit (A-MPDU). Another development introduced to minimize overhead is the concept of Block Acknowledgement (BA). This concept was introduced to work with the aggregate frames such that a burst of up to 64 frames would be individually acknowledged with a single BA frame as opposed to an individual acknowledgement following each frame.

A number of issues are arising from this scenario. One such issue is that, as the window size is increased with the standards from 64 to 128 to 256 and higher, the BA window size will also increase, double or be multiplied. Another issue includes performance degradation as transmission time is increased with the increase in BA window size. Still another issue is the use of one packet per bit in BA when environmental conditions could provide a larger packet size per bit. It is with these and other considerations that the present improvements have been developed.

The 802.11 standard specifies a common Medium Access Control (MAC) Layer which provides a variety of functions that support the operation of 802.11-based wireless LANs (WLANs). The MAC Layer manages and maintains communications between 802.11 stations (such as between radio network cards (NIC) in a PC or other wireless devices or stations (STA) and access points (APs)) by coordinating access to a shared radio channel and utilizing protocols that enhance communications over a wireless medium.

802.11n introduced in 2009, improved maximum single-channel data rate from 54 Mbps of 802.11g to over 100 Mbps. 802.11n also introduced MIMO (multiple input/multiple output), where, according to the standard, up to 4 separate physical transmit and receive antennas carry independent data that is aggregated in a modulation/demodulation process in the transceiver.

The IEEE 802.11ac specification operates in the 5 GHz band and adds channel bandwidths of 80 MHz and 160 MHz with both contiguous and non-contiguous 160 MHz channels for flexible channel assignment. 802.11ac also adds higher order modulation and supports multiple concurrent downlink transmissions (“multi-user MIMO” (MU-MIMO)), which allows transmission to multiple spatial streams to multiple clients simultaneously. By using smart antenna technology, MU-MIMO enables more efficient spectrum use, higher system capacity and reduced latency by supporting up to four simultaneous user transmissions. 802.11ac streamlines the existing transmit beamforming mechanisms which significantly improves coverage, reliability and data rate performance.

IEEE 802.11ax is the successor to 802.11ac and is proposed to increase the efficiency of WLAN networks, especially in high density areas like public hotspots and other dense traffic areas. 802.11ax will also use orthogonal frequency-division multiple access (OFDMA). Related to 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communication system;

FIG. 2 illustrates an exemplary wireless device;

FIG. 3 illustrates an exemplary station;

FIG. 4A illustrates an exemplary Block Acknowledgement (BA) at one packet per bit;

FIG. 4B illustrates an exemplary BA at two packets per bit;

FIG. 5A illustrates an exemplary format of the Block Acknowledge Request (BAR) Control Field;

FIG. 5B illustrates an exemplary format of the Block Acknowledge (BA) Control Field;

FIG. 6 illustrates an exemplary State Field Identity table;

FIG. 7 illustrates an exemplary state machine with an adaptive BA mechanism; and

FIG. 8 is a flowchart illustrating A-MPDU message exchange using adaptive BA.

### DESCRIPTION OF EMBODIMENTS

Embodiments may be implemented as part of Wi-Fi Alliance® Technical Committee Hotspot 2.0 Technical Task Group Hotspot 2.0 (Release 2) Technical Specification, Version 2.04, Jan. 2, 2013. However, the embodiments are not limited to 802.11 standards or Hotspot 2.0 standards. Embodiments can be used in implementation with other wireless communications standards and the like.

In the following detailed description, numerous specific details are set forth in order to provide a thorough understanding of the disclosed techniques. However, it will be understood by those skilled in the art that the present embodiments may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, or the like; and the term “controller” means any device, system or part thereof that controls at least one operation, such a device may be implemented in hardware, circuitry, firmware or software, or combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, and/or the Internet, or within a dedicated secured, unsecured, and/or encrypted system and/or within a network operation or management device that is located inside or outside the network. As an example, a wireless device can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof.

Furthermore, it should be appreciated that the various links, including the communications channel(s) connecting the elements can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, this disclosure is intended to include corresponding and complementary receiver-side functionality in both the same transceiver and/or another transceiver(s), and vice versa.

Presented herein are embodiments of systems, processes, data structures, user interfaces, etc. The embodiments may relate to a communication device and/or communication system. The communication system can include a Wireless Local Area Network (WLAN) connection. A WLAN connection can include communication and association between two or more stations via Aggregate-Media Access Control Protocol Data Unit (A-MPDU) with Block Acknowledgement (BA). The overall design and functionality of the system described herein is, as one example, of a means for providing a more efficient MAC by using an adaptive BA mechanism.

One embodiment provides novel networking mechanisms that enable a station to select a transmission BA state based on an adaptive BA mechanism. The technique generally reduces or removes the need for one to one matching of packets per bit in a BA when environmental conditions provide for a larger number of packets per bit. As a result, a more efficient use of a device MAC is provided, enabling higher system data throughput. Other advantages exist as well as will be discussed herein.

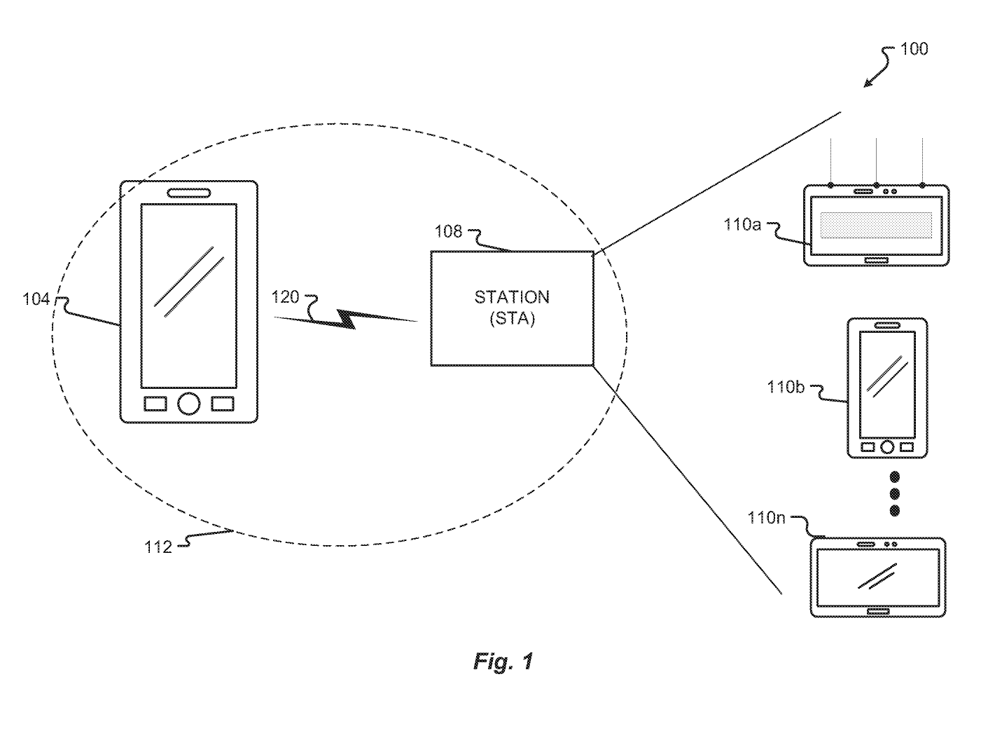

A communication environment 100 may include communication between various devices and stations as shown in FIG. 1. The communication environment 100 can contain multiple communication points, station(s) (STA) 108. The STAs 108 may be any one of an access point 110a, mobile device 110b, tablet 110n, etc. The communication environment 100 can also include one or more wireless devices 104. The wireless device 104 may be a laptop computer, smartphone, wireless device, notebook, subnotebook, a tablet or other electronic computing device or communications device or videogame device, or the like. The wireless device 104 may communicate via a communication channel 120 with STA 108 as it enters a perimeter or geo-fence 112 or comes in proximity with the STA 108. The STA 108 and the wireless device 104 can be mobile or stationary.

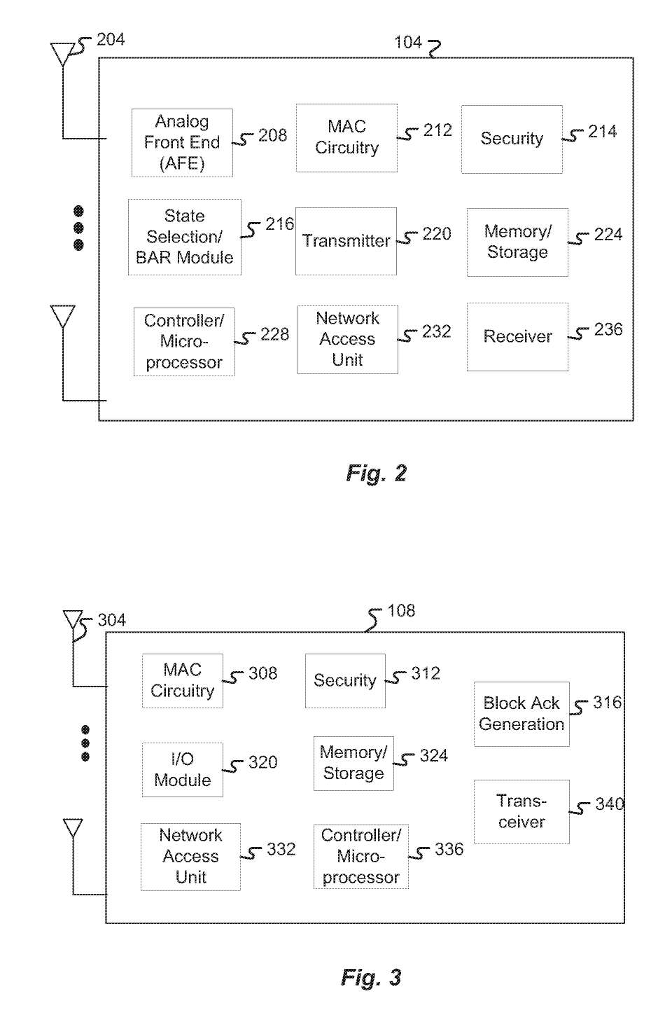

An example of a wireless device 104 architecture is shown in FIG. 2. The wireless device 104 may comprise hardware circuitry and/or software that conduct various operations. The wireless device also includes conventional and well known components which have been omitted for clarity. The operations can include, but are not limited, to conducting calls, synchronizing with stations 108, opening multiple applications, presenting information through audio and/or video means, taking pictures, communicating via a WLAN, etc. The wireless device 104 can be any type of computing system operable to conduct the operations described here. As an example, the wireless device 104 can be a mobile phone which includes and interacts with various modules and components 208-236 as shown in FIG. 2.

The wireless device 104 can have one more antennas 204, for use in wireless communications such as multi-input multi-output (MIMO) communications, Bluetooth®, etc.

The antennas 204 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

Antennas 204 generally interact with an Analog Front End (AFE) module 208, which is needed to enable the correct processing of the received modulated signal. The AFE 208 can sit between the antenna and a digital baseband system in order to convert the analog signal into a digital signal for processing.

The wireless device 104 can also include a controller/microprocessor 228 and a memory/storage 224. The wireless device 104 can interact with the memory/storage 224 which may store information and operations necessary for configuring and transmitting or receiving the message frames described herein. The memory/storage 224 may also be used in connection with the execution of application programming or instructions by the controller/microprocessor 228, and for temporary or long term storage of program instructions and/or data. As examples, the memory/storage 224 may comprise a computer-readable device, RAM, ROM, DRAM, SDRAM or other storage devices and media.

The controller/microprocessor 228 may comprise a general purpose programmable processor or controller for executing application programming or instructions related to the wireless device 104. Further, controller/microprocessor 228 can perform operations for configuring and transmitting message frames as described herein. The controller/microprocessor 228 may include multiple processor cores, and/or implement multiple virtual processors. Optionally, the controller/microprocessor 228 may include multiple physical processors. By way of example, the controller/microprocessor 228 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The wireless device 104 can further include a transmitter 220 and receiver 236 which can transmit and receive signals, respectively, to and from other wireless devices 104 or access points 108 using one or more antennas 204. Included in the wireless device 104 circuitry is the medium access control or MAC Circuitry 212. MAC circuitry 212 provides the medium for controlling access to the wireless medium. In an exemplary embodiment, the MAC circuitry 212 may be arranged to contend for a wireless medium and configure frames or packets for communicating over the wireless medium.

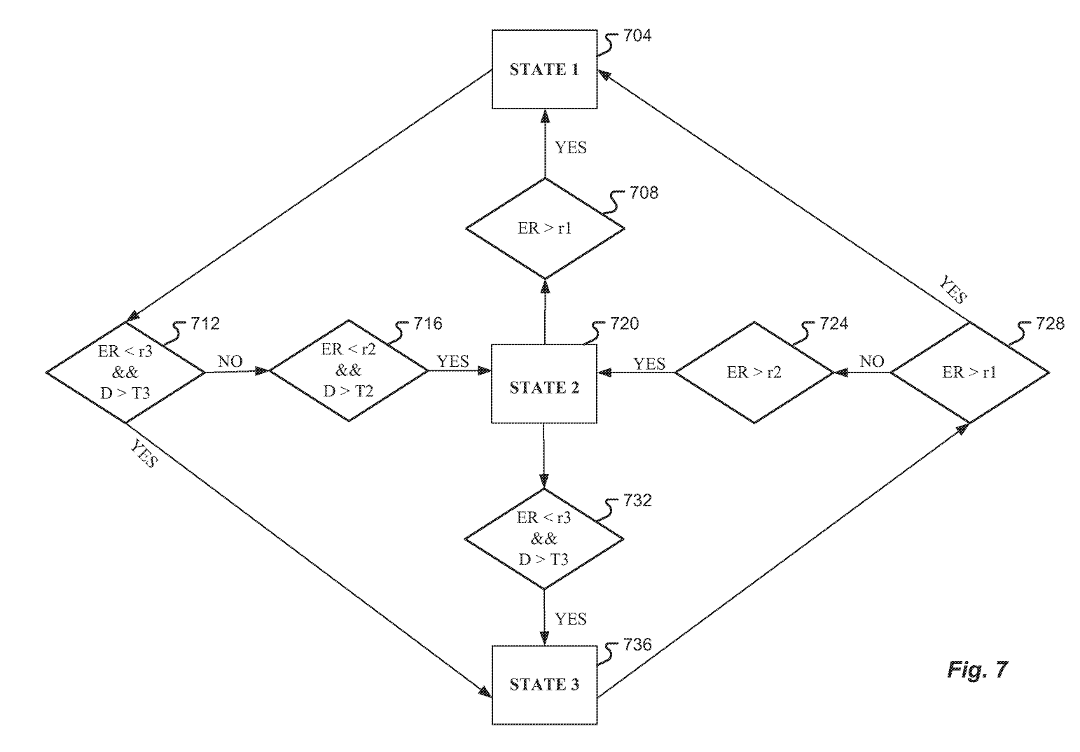

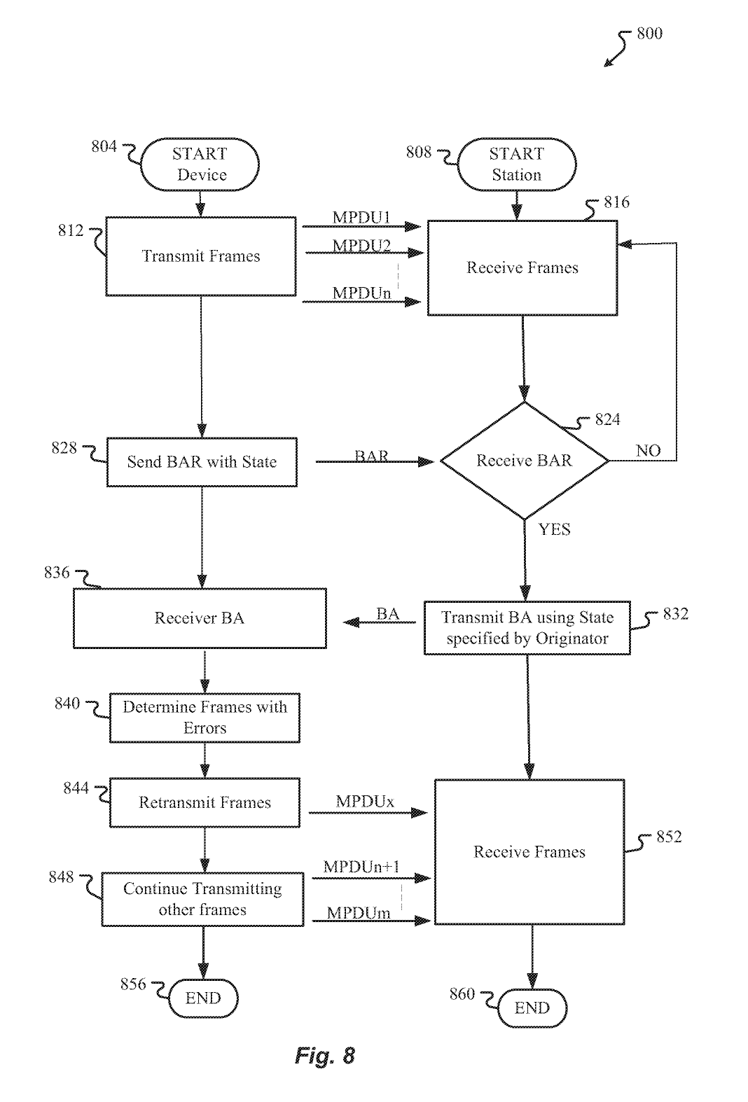

The State Selection/BAR module 216, is a module that can but is not limited to creating the Block Acknowledgement Request (BAR) frame that is transmitted to the station 108 requesting confirmation of receipt of the data frames (i.e., A-MPDU) and is responsible for running the state machine. The state machine, as described below and in conjunction with FIG. 7 is a mechanism that allows adaptive BA such that more/less packets per bit are used for each MPDU.

The wireless device 104 can also contain a security module 214. This security module 214 can contain information regarding but not limited to, security parameters required to connect the wireless device 104 to STA 108 or other available networks, and can include WEP or WPA security access keys, network keys, etc. The WEP security access key is a security password used by Wi-Fi networks. Knowledge of this code will enable the wireless device 104 to exchange information with the station 108. The information exchange can occur through encoded messages with the WEP access code often being chosen by the network administrator. WPA is an added security standard that is also used in conjunction with network connectivity with stronger encryption than WEP.

Another module that the wireless device 104 can include is the network access unit 232. The network access unit 232 can be used for connectivity with the station 108. In one exemplary embodiment, the connectivity can include synchronization between devices. In another exemplary embodiment, the network access unit 232 can work as a medium which provides support for communication with other stations. In yet another embodiment, the network access unit 232 can work in conjunction with at least the MAC circuitry 212. The network access unit 232 can also work and interact with one or more of the modules described herein.

The modules described and others known in the art can be used with the wireless device 104 and can be configured to perform the operations described herein in conjunction with FIG. 1 and FIGS. 3-8.

An example of station 108 architecture is shown in FIG. 3. The station 108 may comprise hardware and/or software that conduct various operations. The station 108 also includes conventional and well known components which have been omitted for clarity. The operations can include, but are not limited, communicating with other STAs, acknowledging packet receipt, synchronizing with wireless devices 104, receiving and processing data frames, etc. The station 108 can be any type of computing system operable to conduct the operations described here. As an example, the station 108 can be a router which includes and interacts with various modules and components 308-340 as shown in FIG. 3.

The station 108 can have one more antennas 304, for use in wireless communications such as multi-input single-output (MISO), single-input multi-output (SIMO), MIMO or the like. The antennas 304 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

The station 108 can also include a controller/microprocessor 336 and a memory/storage 324. The STA 108 can interact with the memory/storage 324 which may store information and operations necessary for configuring and transmitting or receiving the message frames described herein. The memory/storage 324 may also be used in connection with the execution of application programming or instructions by the controller/microprocessor 336, and for temporary or long term storage of program instructions and/or data. As examples, the memory/storage 324 may comprise a computer-readable device, RAM, ROM, DRAM, SDRAM or other storage devices and media.

The controller/microprocessor 336 may comprise a general purpose programmable processor or controller for executing application programming or instructions related to the station 108. Further, controller/microprocessor 336 can perform operations for configuring and transmitting beacons as described herein. The controller/microprocessor 336 may include multiple processor cores, and/or implement multiple virtual processors. Optionally, the controller/microprocessor 336 may include multiple physical processors. By way of example, the controller/microprocessor 336 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

An input/output (I/O) module 320 can also be part of the STA 108 architecture. The input/output module 320 and associated ports may be included to support communications over wired or wireless networks or links. For example, I/O module 320 can provide communication with wireless devices 104, servers, communication devices, and/or peripheral devices. Examples of an input/output module 320 include an Ethernet port, a Universal Serial Bus (USB) port, Institute of Electrical and Electronics Engineers (IEEE) port 1394, or other interface.

The station 108 can further include a transceiver 340 which can transmit and receive signals to and from other wireless devices 104 or stations 108 and/or the Internet using one or more antennas, 204 and 304 respectively, and/or hard-wired links (not shown). Included in the STA 108 architecture is the medium access control or MAC circuitry 308. MAC circuitry 308 provides the medium for controlling access to the wireless medium. In an exemplary embodiment, the MAC circuitry 308 may be arranged to contend for a wireless medium and configure frames or packets for communicating over the wireless medium. The MAC circuitry module 308 can work together or independently of a network access unit 332, which can aid in the communication between wireless devices 104 and connecting to them. In one exemplary embodiment, the connectivity can include synchronization between devices. The network access unit 332 can also work and interact with one or more of the modules described herein.

The Block Ack Generation module 316 can also be part of the station 108 architecture, and can but is not limited to generating the Block Acknowledgement (BA) in response to a Block Acknowledgement Request (BAR) by the wireless device 104, allocating the erroneous bits within the BA and updating the BA control field as necessary. This block Ack generation module 316 can be used independently, in conjunction with, or in addition to other modules with similarly developed functions or which participate in the BA processing.

Station 108 can also contain a security module 312. This security module 312 will contain information regarding, but not limited to, security parameters required to connect the wireless device 104 to STA 108 or other available networks, and can also include WEP or WPA security access keys, network keys, etc. The WEP security access key is a security password used by Wi-Fi networks. Knowledge of this code will provide the wireless device 104 with access to exchange information with the station 108. The information exchange can occur through encoded messages and WEP access code is often chosen by the network administrator. WPA is an added security standard that is also used in conjunction with network connectivity with stronger encryption than WEP.

The modules described and others known in the art can be used with the station 108 and can be configured to perform the operations described herein and in conjunction with FIGS. 1-2 and FIGS. 4-8.

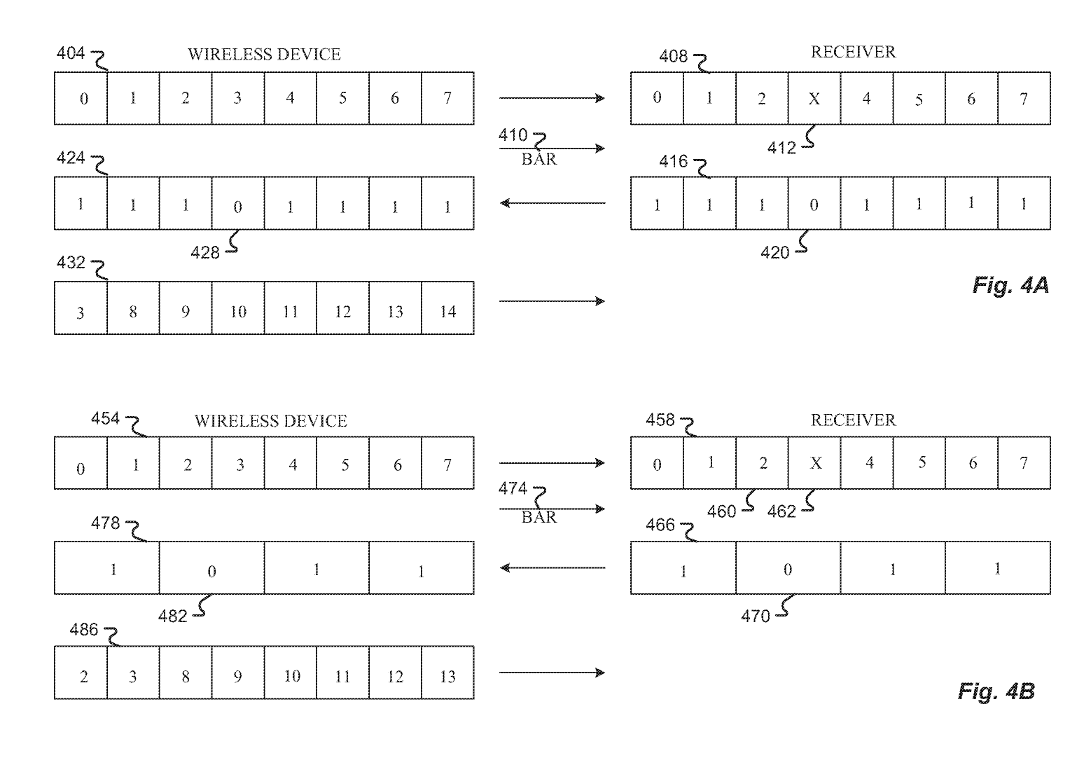

FIG. 4A is an exemplary embodiment of BA at one packet per bit. Block Acknowledgement (BA) is a mechanism established by standards bodies such as but not limited to, IEEE 802.11n, in order to acknowledge receipt of data frames from an originator or wireless device 104. This mechanism was established to improve Media Access Control (MAC) efficiency and is transmitted as a frame to acknowledge multiple MPDUs (i.e., Aggregate—MAC Protocol Data Unit (A-MPDU)). In one embodiment, the originator of the MPDUs, which can be wireless device 104, transmits an A-MPDU, followed by a request for acknowledgment (i.e. Block Acknowledgement Request BAR)) 410 and in return receives a BA from the receiver or station 108.

FIG. 4A, is a simplified version of this BA mechanism. As previously stated, a wireless device 104, transmits a data frame(s) 404, which is received by receiver or STA 108 as data frame 408. Receipt of data frame 408 includes packet 412 which is received with erroneous information. The wireless device 104 continues transmitting data frame(s) 404 until the A-MPDU is complete, at which point the wireless device transmits a BAR 410 requesting acknowledgment of receipt of data frame(s) 404. In response, the STA 108 creates a binary BA frame 416 where 1′s represent correct data and 0′s represent an error in the data. In BA frame 416, packet 412 received in error is represented as a 0 at bit 420. In this BA scheme, there is a one to one mapping of packets to bits, therefore the error at packet 412 is represented by the 0 at bit 420.

BA frame 416 is then transmitted to the wireless device 104 and received as BA frame 424 with bit 428 representing the error obtained by the STA 108. The wireless device 104 takes the BA frame 424 and computes the packet error rate and location of the bad packet and retransmits the bad data in addition to the next set of data frames or packets 432. Further details regarding this operational flow are described below and in conjunction with FIG. 8.

The BA mechanism detailed above can be adapted for use with more than one packet per bit. FIG. 4B is an exemplary embodiment of BA at 2 packets per bit. In other exemplary embodiments, BA can be transmitted at 4 packets per bit, 8 packets per bit, 16 packets per bit, etc. As was the case with FIG. 4A above, an originator or wireless device 104 begins with data frame transmission 454. The data frames can be sent individually or in aggregate form as an A-MPDU. This A-MPDU is received by STA 108 as data frame 458. Again, an error occurs during transmission, and packet 462 contains erroneous information. Data continues to arrive at the receiver until a BAR 474 is received by the STA 108. Upon receipt of the BAR 474, the STA 108 generates a BA acknowledging receipt of data. In the BA, binary information is sent wherein 1′s represent correct data, while 0′s represent an error. In the BA mechanism applied in FIG. 4B, 2 packets per bit BA are being used. Therefore, in BA frame 470, 2 packets are represented by one bit. For example, packet 462 (which is in error) is represented by 0 bit 470. In another example, if packet 460 was in error, bit 470 would similarly be set to 0 also. The BA frame 466 is sent to the wireless device 104 as BA frame 478. The wireless device would take the packets represented by bit 482 and all others in error and prefix them in the next set of data frames to be transmitted as data frame 486. Further details on how and when to use more than one packet per bit is described below and in conjunction with FIG. 7.

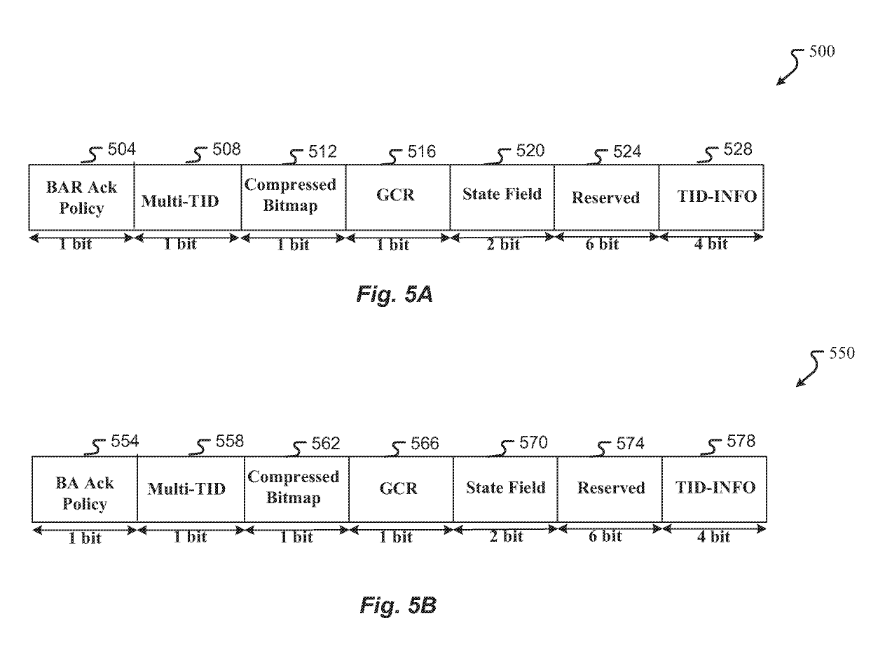

FIG. 5A is an exemplary format of the 16-bit Block Acknowledge Request (BAR) Control Field 500. The BAR Control Field 500 can contain BAR Ack Policy field 504, Multi-Traffic Identifier (Multi-TID) field 508, Compressed Bitmap Field 512, Group Cast Retries (GCR) field 516, State Field 520, Reserved field 524, and TID-INFO field 528. The BAR Ack Policy field 504 is a 1 bit field which indicates whether an Ack is to be sent immediately or delayed after receipt of a Block Acknowledgement Request. If a 0 is transmitted in field 504, the BA is to be sent with a slight delay after receiving the BAR. Alternatively, if a 1 is sent, then the BA is to be transmitted upon BAR reception. The Multi-TID field 508 is a 1 bit identifier with information about the group of frames transmitted. For example, the Multi-TID field 508 can indicate an ID used to group the frames that need a similar Quality of Service (QoS) treatment. In another example, the Multi-TID field 508 can be used to identify whether the BAR includes of different QoS streams.

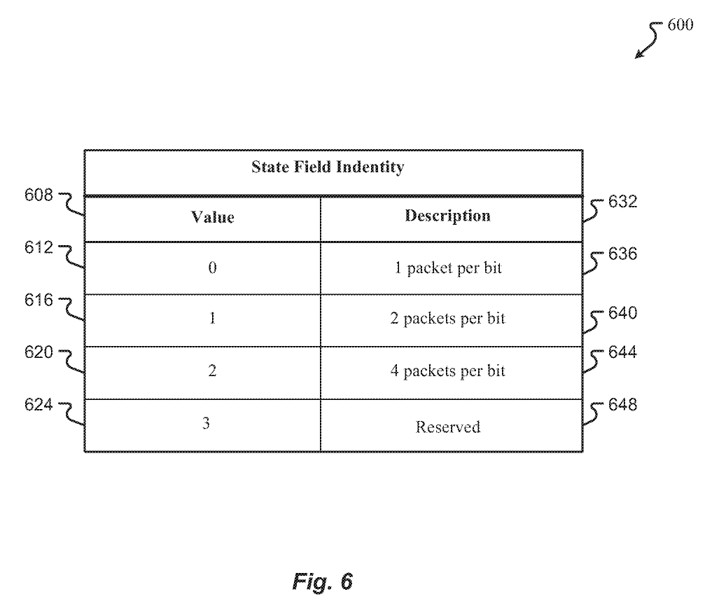

The Compressed Bitmap field 512 is a 1 bit field that indicates whether support exists for Ack in fragments in the BA. The GCR field 516 is a field designed to identify if multiple ACK policies are supported. For example, the GCR field 516 can be used to identify if multicast to unicast conversion is supported. Reserved field 524 is a field that reserves 6 bits for future use. The bits can be used in conjunction with other BAR control fields or independently to define separate functions and/or support available in the A-MPDU transmission. The TID-INFO field 528 is a 4 bit field used to provide information about each of the Traffic Identifiers. The State Field 520 is a 2 bit field used to express the state the wireless device is currently using for BA. As described below and in conjunction with FIGS. 6-8, the BA can represent 1, 2, 4, etc., packets per bit. Determining the frequency is a function of the probability of error and duration of the frame. The state machine embodied in FIG. 7 explains this and FIG. 6 provides a 1:1 mapping of the state value and corresponding BA transmission.

FIG. 5B illustrates an exemplary format of the 16-bit Block Acknowledge (BA) Control Field 550. Similar to BAR Control Field 500, the BA Control Field 550 also includes BA Ack Policy field 554, Multi-Traffic Identifier (Multi-TID) field 558, Compressed Bitmap Field 562, Group Cast Retries (GCR) field 566, State Field 570, Reserved field 574, and TID-INFO field 578. Fields 554-578 can be the same or different than those in the BAR Control Field 550. In some instances, the corresponding BA field can be updated to match the BAR Control Field parameter. The BA Ack Policy field 554 is a 1 bit field which indicates whether an Ack is to be sent immediately or delayed after receipt of a Block Acknowledgement. The Multi-TID field 558 is a 1 bit identifier with information about the group of frames transmitted. The Compressed Bitmap field 562 is a 1 bit field that indicates whether support exists for Ack for fragments in the BA. The GCR field 566 is a field designed to identify if multiple ACK policies are supported. Reserved field 574 is a field that reserves 6 bits for future use. The TID-INFO field 578 is a 4 bit field used to provide information about each of the TID. The TID-INFO field 578 and Multi-TID field 558 can be different, the same or be updated to match the corresponding BAR Control Field 500 TID values 508 and 528. The State Field 570 is a 2 bit field used to express the state the wireless device 104 is currently using for BA. As the packet error rate changes and corresponding state changes at the originator or wireless device 104, the BAR sends a change in the state field 520 and is updated in the corresponding state field 570 on the BA Control Field 550. Further details on the change and update are described below and in conjunction with FIGS. 6-8.

FIG. 6 illustrates an exemplary embodiment of a State Field Identity table 600 for listings of various state values 608 that are available for use in the BA and BAR control fields as described above and in conjunction with FIGS. 5A and 5B. The State Field Identity table 600 provides some examples of state values 608 that could reside in Value field 520 and 570 in FIGS. 5A and 5B respectively. Various values are listed in the State Field Identity table 600 ranging from value 0 in field 612 to value 3 in field 624 with corresponding description fields 632 ranging from fields 636-648. For example, value 0 in field 612 can represent a state with a BA at 1 packet per bit as indicated in description field 636. Another state value could be identified as value 1 in field 616 with corresponding description field 640 indicating a BA at 2 packets per bit. Similarly, value 2 in field 620 can correspond to field 644 indicating a BA at 4 packets per bit. Value 3 in field 624 is a state value that is reserved for future use as indicated in field 648. The reserved value 3 can be used in to represent state 3, 4 and beyond as the BAs are transmitted at larger packets per bit (i.e., 8 bits per packet, 16 bits per packet, etc.). Value 3 can also be used to represent other data or support available through BA or BAR or as identified in a BA or BAR control field. In general, the State Field Identity table 600 can include any value as needed for the BA or BAR control fields.

FIG. 7 illustrates an exemplary embodiment of a state machine with an Adaptive BA mechanism. The state machine in FIG. 7 contains 3 states, however more or less states are possible. Any changes in state take place at the wireless device 104 (i.e., originator), which notifies the receiver or station 108 of such change. The BA size is based on the state and the window size and provides a more granular look at the channel conditions. As the environment changes, more or less packets per bit can be used with the BA.

When a Block Ack agreement is established between wireless device 104 and a station 108, the wireless device 104 begins to run the state machine at State 1 704 as illustrated in FIG. 7. At State 1 704, the BA mechanism is the same as the traditional IEEE 802.11n protocol, where the BA works at 1 packet per bit. The state machine while at State 1 704, begins with the wireless device 104 detecting the packet error rate (ER) and duration time (D) of the frames periodically. As condition 712 with an ER<r3 and D>T3, the wireless device 104 moves to State 3 736. That is if the rate at which the errors are received are less than a threshold rate r3 and greater than a duration T3, then environment conditions allow for more packets per bit in the BA. However, if condition 712 fails, then the wireless device 104 will check whether condition 716 is true. In condition 716, ER<2 and D>T2 is true, then the wireless device 104 moves to State 2 720. Otherwise, the wireless device 104 continues to detect the packet error rate periodically until one of the conditions is met.

At State 2 720, one bit in the BA represents 2 packets. Further details regarding this type of BA mechanism are described above and in conjunction with FIG. 4B. As described above, in a BA where both packets are successfully received, the packet is represented by a 1 in the BA bit field, otherwise the bit in the BA is 0. Again, similar to State 1 704, at State 2 720, the wireless device 104 detects and monitors the packet error rate (ER) and duration time (D) periodically. As a condition is true, such as condition 732 is true, the wireless device 104 moves to State 3 736. For the wireless device 104 to move to condition 732 and onto State 3 736, the ER<3 and D>T3, that is very good channel conditions exist such that more packets can be represented by 1 bit (i.e., 4 packets per bit). However, if instead condition 708 is true, then wireless device 104 moves to State 1 704. In this instance, environmental conditions worsen requiring a need for 1 packet per bit BAR. Otherwise, if neither condition is true, the wireless device 104 continues to detect the error rate periodically.

At State 3 736, if all the four packets are successfully received, the bit representing those packets on the BA is 1, otherwise the bit in the BA is 0. The wireless device 104 again, continues detecting the packet error rate periodically and once another condition is true, the wireless device moves to the next state. For example, if condition 728 is true, where ER>r1, then the wireless device moves to State 1 704. However, if condition 728 fails and condition 724 is true, then the wireless device moves to State 2 720. Otherwise, the wireless device 104 continues to detect the packet error rate periodically until the next condition is true.

Once the wireless device 104 moves to a new state, the wireless device 104 sends a Block Acknowledgement Request (BAR) to the station 108 to notify the station 108 of a state change. Further details describing the State change and field location in the BA and BAR are included above and in conjunction with FIGS. 5A and 5B.

FIG. 8 outlines an exemplary flowchart illustrating A-MPDU message exchange using adaptive BA. In particular, association between two devices, such as a wireless device 104 and station 108, begins at step 804 and 808, for each device respectively, and continues to step 812. In step 812, the wireless device 104 transmits a plurality of data frames (i.e., data MPDUs) in an Aggregate MAC Protocol Data Unit (A-MPDU) message to the station 108. The number of data frames transmitted can vary from 1 to n frames as illustrated in FIG. 8 by MPDU1 to MPDUn. In one example, 64 consecutive frames can be transmitted. In another example, the number of consecutive frames transmitted can be 128. In yet another example, 256 consecutive frames can be transmitted. In step 816, the station 108 receives the plurality of data frames sent by the wireless device 104 and listens for a Block Acknowledgement Request (BAR) from the wireless device in step 824. If no BAR is received, the station continues to receive MPDUs at step 816. Alternatively, if a BAR is received, the station 108 responds with a Block Acknowledgement (BA) in step 832.

After sending the A-MPDU frame, the wireless device can send a Block Acknowledgement Request (BAR) to the station in step 828. The Block Acknowledgement Request is a request from the wireless device 104 to the station 108 for acknowledgement that the block of frames or A-MPDU were received. In response, as previously stated, the station transmits the (BA) in step 832. The BA contains a bitmap which represents the success and/or failure of an A-MPDU received by the station 108. In addition to the bitmap, the BA control field also includes information detailing the current state in which the wireless device 104 is operating. State information is sent in the BAR control field and is updated on the BA. Further details regarding state information are described above and in conjunction with FIGS. 1-7.

The process then continues to step 840 where the wireless device determines the errors in the A-MPDU and detects the corresponding packet error rate which is used to determine state information. The frames with errors are identified and retransmitted as MPDUx, in step 844 and the process continues to step 848 where transmission continues to the remaining frames; MPDUn+1 to MPDUm. The station receives the retransmitted frames and the next set of data frames in step 852. As shown in FIG. 8, the retransmitted frames are illustrated by MPDUx and the new frames as MPDUn+1 to MPDUm. Further details describing state determination and frame transmission are explained in greater detail above and in conjunction with FIGS. 1-7. Once the new set is transmitted and received, the method restarts and the process ends at step 856 and 860 for both the wireless device and the station respectively.

Embodiments are thus directed toward a wireless device for transmitting frames, comprising: a memory; a processor; and a transceiver, the transceiver configured to: transmit a plurality of data frames; transmit a block acknowledgement request (BAR) including state information, at the completion of the transmission of the data frames; receive a block acknowledgment (BA) in response to the transmitted BAR; determine a packet error rate at least based on the received BA; determine an updated state based in part on the packet error rate determined from a number of the data frames that contained an error; and retransmit the data frames that contain the error. Aspects of the above wireless device include wherein the data frames are an Aggregate-Media Access Control Protocol Data Unit (A-MPDU). Aspects of the above wireless device further comprising transmitting the updated state in a state field of a BAR control field. Aspects of the above wireless device include wherein if the updated state differs from a current state, the updated state transmitted in the BAR control field triggers an update in a BA control field. Aspects of the above wireless device include wherein determining the updated state is a function of the packet error rate and time duration of the data frames transmitted. Aspects of the above wireless device include wherein when the packet error rate is less than a first pre-determined rate and the time duration of the data frames transmitted is greater than a pre-determined time period a state change will occur, wherein the state change includes increasing a number of packets per bit. Aspects of the above wireless device include wherein when the packet error rate is greater than a second pre-determined rate the state change occurs, wherein the state change includes decreasing the number of packets per bit. Aspects of the above wireless device further comprising establishing a block acknowledgement agreement.

Embodiments include a method for transmitting a plurality of data frames, the method comprising: transmitting, by a transceiver, a block acknowledgement request (BAR) at the completion of the transmission of the data frames; receiving, by the transceiver, a block acknowledgment (BA) in response to the transmitted BAR; determining, by a processor, a packet error rate based at least on the received BA; determining, by the processor, an updated state based in part on the packet error rate determined from a number of the data frames that contained an error; and retransmitting, by the transceiver, the data frames that contain the error. Aspects of the above method include wherein the data frames are an Aggregate-Media Access Control Protocol Data Unit (A-MPDU). Aspects of the above method further comprising transmitting the updated state in a state field of a BAR control field. Aspects of the above method include wherein if the updated state differs from a current state, the updated state transmitted in the BAR control field triggers an update in a BA control field. Aspects of the above method include wherein determining the updated state is a function of the packet error rate and time duration of the data frames transmitted. Aspects of the above method include wherein when the packet error rate is less than a first pre-determined rate and the time duration of the data frames is greater than a pre-determined time period a state change will occur, wherein the state change includes increasing a number of packets per bit. Aspects of the above method include wherein when the packet error rate greater than a second pre-determined rate the state change occurs, wherein the state change includes decreasing the number packets per bit. Aspects of the above method include wherein the packet error rate and the state are a function of environmental changes, wherein a good environment decreases packet error rate and calls the state with the plurality of packets per bit representation in the BA.

Embodiments include a non-transitory computer readable medium having instructions thereon that when executed by at least one processor of a wireless device perform a method comprising: transmitting, by the transceiver, a plurality of data frames; transmitting, by the transceiver, a block acknowledgement request (BAR) at the completion of the transmission of the data frames; receiving, by the transceiver, a block acknowledgment (BA) in response to the transmitted BAR; determining, by a processor, a packet error rate based at least on the received BA; determining, by the processor, an updated state based in part on the packet error rate determined from the a number of the data frames that contained an error; and retransmitting, by the transceiver, the data frames containing the error. Aspects of the above media include wherein the data frames are an Aggregate-Media Access Control Protocol Data Unit (A-MPDU). Aspects of the above media further comprising transmitting the updated state in a state field of a BAR control field. Aspects of the above media include wherein if the updated state differs from a current state, the updated state transmitted in the BAR control field triggers an update in a BA control field. Aspects of the above media include wherein when the packet error rate is less than a first pre-determined rate and the time duration of the data frames is greater than a pre-determined time period a state change will occur, wherein the state change includes increasing a number of packets per bit. Aspects of the above media include wherein when the packet error rate greater than a second pre-determined rate the state change occurs, wherein the state change includes decreasing the number of packets per bit.

Embodiments include a system comprising: means for transmitting a plurality of data frames; means for transmitting a block acknowledgement request (BAR) at the completion of the transmission of the data frames; means for receiving a block acknowledgment (BA) in response to the transmitted BAR; means for determining a packet error rate based at least on the received BA; means for determining an updated state based in part on the packet error rate from a number of the data frames that contained an error; and means for retransmitting the data frames containing the error. Aspects of the above system include wherein the data frames are an Aggregate-Media Access Control Protocol Data Unit (A-MPDU). Aspects of the above system further comprising transmitting the updated state in a state field of a BAR control field. Aspects of the above system include wherein if the updated state differs from a current state, the state determined transmitted in the BAR control field triggers an update in a BA control field. Aspects of the above system include wherein when the packet error rate is less than a first pre-determined rate and the time duration of the data frames is greater than a pre-determined time period a state change will occur, wherein the state change includes increasing a number of packets per bit. Aspects of the above system include wherein when the packet error rate greater than a second pre-determined rate the state change occurs, wherein the state change includes decreasing a number of packets per bit.

Embodiments include device comprising: a memory; a processor; and a transceiver, the transceiver configured to: receive a plurality of data frames; receive a block acknowledgement request (BAR) including state information, at the completion of the reception of the data frames; transmit a block acknowledgment (BA) in response to the received BAR; and receive the data frames that contain an error. Aspects of the above device include wherein the data frames are an Aggregate-Media Access Control Protocol Data Unit (A-MPDU). Aspects of the above device include wherein if the state information in the received BAR includes an updated state, a state field in a BA control field is updated. Aspects of the above device include wherein receiving the data frames that contain the error further includes receiving new data frames. Aspects of the above device further comprising establishing a block acknowledgement agreement.

The exemplary embodiments are described in relation to an adaptive Block Acknowledgement mechanism in a wireless communication between two or more devices. However, it should be appreciated, that in general, the systems and methods herein will work equally well for any type of communication system in any environment utilizing any one or more protocols including wired communications, wireless communications, powerline communications, coaxial cable communications, fiber optic communications and the like.

The exemplary systems and methods are described in relation to IEEE 802.11 transceivers and associated communication hardware, software and communication channels. However, to avoid unnecessarily obscuring the present disclosure, the following description omits well-known structures and devices that may be shown in block diagram form or otherwise summarized.

For purposes of explanation, numerous details are set forth in order to provide a thorough understanding of the present embodiments. It should be appreciated however, that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, 802.11u, WiFi, LTE, LTE Unlicensed, 4G, Bluetooth®, WirelessHD, WiGig, 3GPP, Wireless LAN, WiMAX.

The term transceiver as used herein can refer to any device that comprises hardware, software, firmware, or combination thereof and is capable of performing any of the methods described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA.RTM. or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that systems and methods for an adaptive BA mechanism for communication between two or more stations have been presented. While the embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A wireless device, comprising:
a memory;
a processor; and
a transceiver, the transceiver configured to:
transmit a plurality of data frames;
transmit a block acknowledgement request (BAR) including state information, at the completion of the transmission of the data frames;
receive a block acknowledgment (BA) in response to the transmitted BAR;
determine a packet error rate at least based on the received BA;
determine an updated state based in part on the packet error rate determined from a number of the data frames that contained an error; and
retransmit the data frames that contain the error.

2. The wireless device of claim 1, wherein the data frames are an Aggregate-Media Access Control Protocol Data Unit (A-MPDU).

3. The wireless device of claim 1, further comprising transmitting the updated state in a state field of a BAR control field.

4. The wireless device of claim 3, wherein if the updated state differs from a current state, the updated state transmitted in the BAR control field triggers an update in a BA control field.

5. The wireless device of claim 3, wherein determining the updated state is a function of the packet error rate and time duration of the data frames transmitted.

6. The wireless device of claim 5, wherein when the packet error rate is less than a first pre-determined rate and the time duration of the data frames transmitted is greater than a pre-determined time period a state change will occur, wherein the state change includes increasing a number of packets per bit.

7. The wireless device of claim 6, wherein when the packet error rate is greater than a second pre-determined rate the state change occurs, wherein the state change includes decreasing the number of packets per bit.

8. The wireless device of claim 1, further comprising establishing a block acknowledgement agreement.

9. A method comprising:
transmitting, by a transceiver, a plurality of data frames;
transmitting, by the transceiver, a block acknowledgement request (BAR) at the completion of the transmission of the data frames;
receiving, by the transceiver, a block acknowledgment (BA) in response to the transmitted BAR;
determining, by a processor, a packet error rate based at least on the received BA;
determining, by the processor, an updated state based in part on the packet error rate determined from a number of the data frames that contained an error; and
retransmitting, by the transceiver, the data frames that contain the error.

10. The method of claim 9, wherein the data frames are an Aggregate-Media Access Control Protocol Data Unit (A-MPDU).

11. The method of claim 9, further comprising transmitting the updated state in a state field of a BAR control field.

12. The method of claim 9, wherein if the updated state differs from a current state, the updated state transmitted in the BAR control field triggers an update in a BA control field.

13. The method of claim 9, wherein determining the updated state is a function of the packet error rate and time duration of the data frames transmitted.

14. The method of claim 13, wherein when the packet error rate is less than a first pre-determined rate and the time duration of the data frames is greater than a pre-determined time period a state change will occur, wherein the state change includes increasing a number of packets per bit.

15. The method of claim 14, wherein when the packet error rate greater than a second pre-determined rate the state change occurs, wherein the state change includes decreasing the number packets per bit.

16. The method of claim 15, wherein the packet error rate and the state are a function of environmental changes, wherein a good environment decreases packet error rate and calls the state with the plurality of packets per bit representation in the BA.

17. A non-transitory computer readable medium having instructions thereon that when executed by at least one processor of a wireless device perform a method comprising:
transmitting, by the transceiver, a plurality of data frames, wherein the data frames are an Aggregate-Media Access Control Protocol Data Unit (A-MPDU);
transmitting, by the transceiver, a block acknowledgement request (BAR) at the completion of the transmission of the data frames;
receiving, by the transceiver, a block acknowledgment (BA) in response to the transmitted BAR;
determining, by a processor, a packet error rate based at least on the received BA;
determining, by the processor, an updated state based in part on the packet error rate determined from the number of the data frames that contained an error; and
retransmitting, by the transceiver, the data frames containing the error.

18. The non-transitory medium of claim 17, further comprising transmitting the updated state in a state field of a BAR control field, and wherein if the updated state differs from a current state, the updated state transmitted in the BAR control field triggers an update in a BA control field.

19. The non-transitory medium of claim 17, wherein when the packet error rate is less than a first pre-determined rate and the time duration of the data frames is greater than a pre-determined time period a state change will occur, wherein the state change includes increasing a number of packets per bit.

20. The non-transitory medium of claim 19, wherein when the packet error rate greater than a second pre-determined rate the state change occurs, wherein the state change includes decreasing the number of packets per bit.

21-23. (canceled)

24. A device comprising:
a memory;
a processor; and
a transceiver, the transceiver configured to:
receive a plurality of data frames;
receive a block acknowledgement request (BAR) including state information, at the completion of the reception of the data frames;
transmit a block acknowledgment (BA) in response to the received BAR; and
receive the data frames that contain an error.

25. The device of claim 24, wherein the data frames are an Aggregate-Media Access Control Protocol Data Unit (A-MPDU).

26. The device of claim 24, wherein if the state information in the received BAR includes an updated state, a state field in a BA control field is updated.

27. The device of claim 24, wherein receiving the data frames that contain the error further includes receiving new data frames.

28. The device of claim 24, further comprising establishing a block acknowledgement agreement.
